(19) United States
(12) Patent Application Publication
(10) Pub. No.: US 2017/0044674 A1
(43) Pub. Date: Feb. 16, 2017

(54) MULTILAYER COATING METHOD FOR PREVENTING EROSION OF CAVITATION

(71) Applicant: Hwal Gyeong SEONG, Changwon- si (KR)

(72) Inventor: Hwal Gyeong SEONG, Changwon- si (KR)

(21) Appl. No.: 15/137,265

(22) Filed: Apr. 25, 2016

(30) Foreign Application Priority Data
Aug. 13, 2015 (KR) 10-2015-0114330

(51) Int. Cl. C23C 26/00; B05D 5/00; C01B 31/02; B05D 7/00; B05D 3/10; B05D 3/12; B05D 7/14

(52) U.S. Cl. CPC C23C 26/00; B05D 3/12; B05D 5/00; B05D 7/14; B05D 7/54; B05D 3/102; C01B 31/0273; B63H 1/18

(57) ABSTRACT

The present invention relates to a multilayer coating method for preventing erosion due to cavitation capable of enhancing adhesion with a coating layer, reducing waste of the material by a bonding method of a film prepared during top coating, and simplifying a process even while ensuring wear resistance and high stiffness of the material itself by surface-treating the material by a different method from the related art.

### CROSS-REFERENCE TO RELATED APPLICATION

This application claims the benefit of Korean Application No. 10-2015-0114330, filed on Aug. 13, 2015 with the Korean Intellectual Property Office, the disclosure or which is incorporated herein by reference.

### BACKGROUND OF THE INVENTION

1. Field of the Invention

The present invention relates to a multilayer coating method for preventing erosion due to cavitation caused according to a flow of fluid in a propeller, a screw, or a rudder and preventing the erosion due to cavitation capable of improving durability, during sailing of a ship.

2. Description of the Related Art

In general, cavitation means a phenomenon in which a cavity is generated in fluid due to a change in pressure depending on a change in velocity of the fluid and is called a cavitation phenomenon. That is, the cavitation is a phenomenon in which pressure in the liquid is lowered to vapor pressure or less when the liquid moves at a rapid velocity to generate vapor bubbles in the liquid. Accordingly, when a density ratio between water and vapor is considered as about 1000:1, the inside of the cavity may be called a relatively empty portion, that is, the cavity in terms of a dynamic aspect.

In ships, the aforementioned cavitation is generated depending on a loading state of a propellant device, such as a propeller, a screw, or a rudder during sailing. That is, generally, in large ships or high-speed ships, large propulsion is required in the propeller even at a general sailing speed, and a pressure difference largely occurs on both front and rear sides of the propeller. That is, at a wing side of a direction receiving the front pressure, the pressure is increased, and at a wing side of a direction receiving rear suction, the pressure is decreased.

In this case, when the pressure of the liquid such as water drops even though there is no temperature difference, the liquid such as the water cannot be in a liquid state any longer and is changed to gas and in the case of the water, there is a pressure (15° C., approximately 3 kPa) which causes the liquid to be phase-changed to the gas at a predetermined temperature and this is referred to as a vapor pressure.

As a result, when a pressure on a propeller intake surface is lower than the vapor pressure while the ship is operated, the water that passes through the propeller is momentarily changed to the vapor and the pressure is restored originally again, and as a result, while the pressure increases to the vapor pressure or higher, an object which is changed to the water again is changed and numberless bubbles are generated and collapsed as a phenomenon observed visually.

The bubble collapse accompanied by the cavitation generation causes fast fluidization, a pressure change, and a temperature change to consequently bring about noise and damage. For example, as the damage, there is damage doe to a shock wave and damage due to micro jet and vibration and the noise are generated, and as a result, propulsion efficiency is reduced due to an increase of cavity drag, a propeller wing is eroded, and the like.

Accordingly, various technologies are developed in order to prevent the erosion due to the cavitation and for example, ‘Composition for Erosion Prevention of Ship of Rudder’ of Korean Patent Unexamined Publication No. 10-2007-0074765, ‘Composite Materials Resistant to Wear and Process for Composite Materials’ of U.S. Pat. No. 5,527,849’, ‘Intumescent Coating Compositions’ or US Patent: Unexamined Publication No. 2009-0142495, and the like are proposed and ‘Coating Method for Prevention of Abrasion by Cavitation’ of Korean Patent Registration No. 10-1444265 applied and registered by the present applicant in order to enhance the related art is provided.

However, the related art applied and registered by the present applicant still has a problem in the related arc and first, plating or dotting processing using inorganic metal is performed on the surface of a material is performed in order to increase adhesive force of a coating layer, but the adhesive of the surface processing of the material is enhanced, but the surface processing thereof still has a problem in that wear resistance of the material itself cannot be secured. Second, in multilayer coating, liquid paint in which polyurethane and carbon nanotube are mixed is used and applied by a spray method at the times of middle and top coating, and as a result, a control and a process for application with a predetermined thickness are complicated and multiple-staged and there is a problem in that sufficient wear resistance and high strength cannot be secured together with a problem in that materials are wasted, and the like.

### SUMMARY OF THE INVENTION

An object of the present invention is first to provide a multilayer coating method for preventing erosion due to cavitation capable of enhancing adhesion to a Coating layer while ensuring wear resistance and high stiffness of the material by surface-treating a material by a different method from the related art.

Second, another object of the present invention is to provide a multilayer coating method for preventing erosion due to cavitation capable of more improving wear resistance and high stiffness while performing multilayer coating by a different method from the in the related art, reducing consumption of the material by a method of bonding a film which is prepared during top coating in the multilayer coating, and simplifying a process.

Third, yet another object of the present invention is to provide a multilayer coating method for preventing erosion due to cavitation capable of providing a specific penetration method of thermoplastic polyurethane to a carbon nanotube film formed together with a particular forming method of the carbon nanotube film for top coating and ensuring wear resistance and high stiffness which are further enhanced as compared with the related art by ensuring an optimal penetration amount.

The objects, features and advantages of the present disclosure will, be more clearly understood from the following detailed description of the exemplary embodiments taken in conjunction with the accompanying drawings.

According to an aspect of the present invention, a multilayer coating method for preventing erosion due to cavitation includes: surface-treating for performing shot blasting or shot for curing the surface of a material and increasing a fatigue strength by injecting hard particles and generating residual compressive stress on the surface of the material so that minute unevenness is formed on the surface of the material; and multilayer coating for sequentially performing bottom, middle and top coating with respect to the material in which surface treatment is completed, in which the multilayer coating includes bottom coating for forming a primer layer by using an organic primer, middle coating for forming a TPU layer by using thermoplastic polyurethane (TPU), and top coating for forming and bonding a BP/TPU complex layer by penetrating a thermoplastic polyurethane solution into a previously prepared carbon nanotube (CNT) film.

Further, the surface-treating may include material degreasing for degreasing caustic soda and a decreasing agent on the surface of the material at 50° C. for 5 minutes, and shot blasting for performing shot blasting or shot peening on the surface of the decreased material for 5 seconds.

The CNT film may be prepared to be a film having a thickness of approximately 20 μm by distributing and processing the carbon nanotube having purity of 55% or higher, a an appropriate amount of surfactant, and distilled water by using an ultrasonicator for 20 minutes, centrifuging a mixed solution in a centrifugal of 4,000 rpm for 30 minutes and taking a floating part where the carbon nanotube is largely agglomerated in the centrifuged mixed solution, and passing the floating part through a membrane filter having a hole size of 0.22 μm.

The top coating may include a TPU/DMF mixing for forming a TPU/DMF mixed solution by mixing the TPU solution and dimethyl formamide (DMF) of 0.01 wt. %, a TPU/DMF penetrating for penetrating the TPU/DMF mixed solution into the CNT film in a vacuum state, a DMF removing for forming the BP/TPU complex layer by drying the CNT film into which the TPU/DMF mixed solution is penetrated in the vacuum state of 60° C. for 24 hours to remove the dimethyl formamide, and a BS/TPU bonding for bonding the BP/TPU complex layer from which the DMF is removed onto the TPU layer which is middle-coated.

In the BP/TPU complex layer, the residual porosity of the CNT film may be 5.5 to 6.5 Vol %.

In the BP/TPU complex layer, the content of the thermoplastic polyurethane may be 45 to 50 Vol %.

In the BP/TPU complex layer, the residual porosity of the CNT film may be 5.9 Vol % and the content of the thermoplastic polyurethane may foe 47.9 Vol %.

As described above, in the multilayer coating method for preventing erosion due to cavitation according to the present invention, first, it is possible to enhance adhesion to a primer layer in bottom coating through a minute unevenness even while ensuring wear resistance and high stiffness of a material itself by surface-treating the material by shot peening or shot blasting.

Second, it is possible to enhancing adhesion between a primer layer primer-coated through middle coating in which a TPU layer is formed by using thermoplastic polyurethane (TPU) and a BP/TPU complex layer in the top coating and distributing impact applied to the BP/TPU complex layer by absorbing the impact due to the cavitation through high flexibility and elasticity.

Third, it is possible to greatly reduce erosion due to the cavitation while the TPU layer and the BP/TPU complex layer which are intermediate-coated through the top coating in which the BP/TPU complex layer is formed and bonded by penetrating a thermoplastic polyurethane solution to a carbon nanotube (CNT) film are strongly bonded with each other by the TPU formed by the same material and high toughness is maintained by the CNT film of the top-coated BP/TPU complex layer.

Particularly, it is possible to provide a characteristic penetration method of thermoplastic polyurethane to the CNT film formed together with the specific forming method of the CNT film during top coating and ensure wear resistance and high stiffness which are further enhanced as compared with the related art by ensuring an optimal penetration amount.

### BRIEF DESCRIPTION OF THE DRAWINGS

FIG. 1 is a flowchart illustrating a multilayer coating method for preventing erosion due to cavitation according to an exemplary embodiment of the present invention.

FIG. 2 is a perspective view illustrating a coating layer which is multilayer-coated to a material according to the exemplary embodiment of FIG. 1.

FIG. 3 is a flowchart illustrating a multilayer coating method for preventing erosion due to cavitation according to another exemplary embodiment of the present invention.

FIG. 4 is a diagram illustrating a specimen performing surface-treating on the material by shot blasting in another exemplary embodiment of FIG. 3 and a surface-treated specimen in the related art.

FIG. 5 is a diagram illustrating a testing result of accelerating the erosion due to the cavitation after bottom-coating the specimens prepared in FIG. 4.

FIG. 6 is a comparison table illustrating a cumulative erosion amount of the specimen for the testing result of accelerating the erosion due to the cavitation of FIG. 5.

FIG. 7 is a perspective view illustrating a chemical structure of a carbon nanotube prepared in the top coating and a filmed carbon nanotube film according to another exemplary embodiment of FIG. 3.

FIG. 8 is a flowchart illustrating a detailed process Of the top coating according to another exemplary embodiment of FIG. 3.

FIG. 9 is a comparison table of property values per Vol % of a penetration amount and a porosity of thermoplastic polyurethane for a carbon nanotube film of a BP/TPU complex layer in which top coating is competed through the another exemplary embodiment of FIG. 3.

### DETAILED DESCRIPTION OF THE PREFERRED EMBODIMENTS

Hereinafter, preferable exemplary embodiments of a multilayer coating method for preventing erosion of cavitation, according to the present invention will be described in detail with reference to the accompanying drawings.

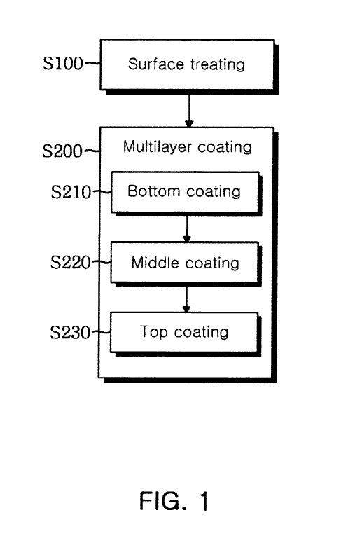

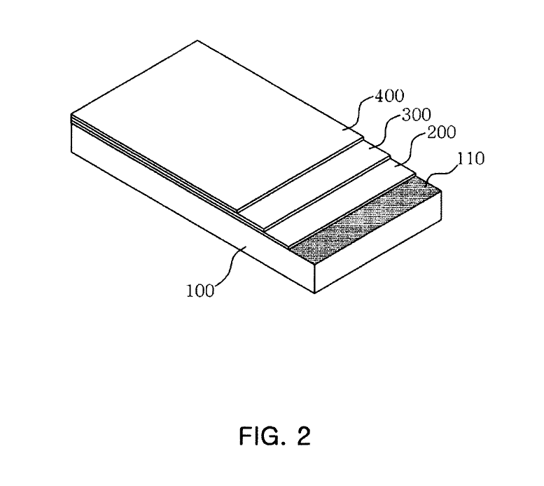

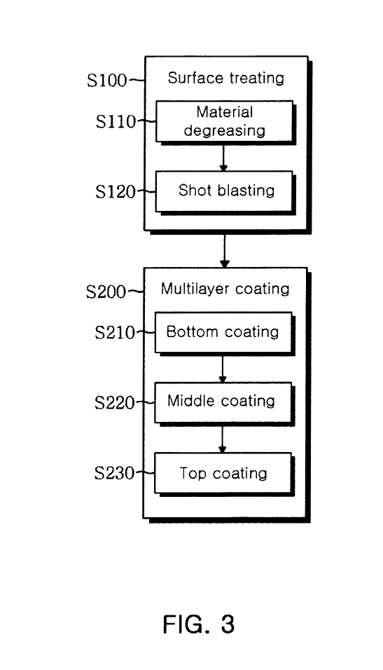

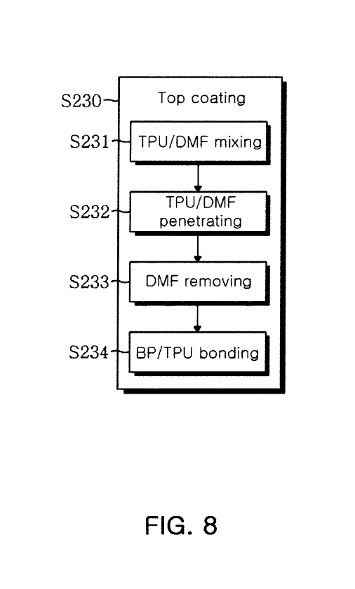

The multilayer coating method for preventing erosion due to cavitation according to the present invention includes surface-treating (S100) and multilayer coating (S200), and the multilayer coating (S200) includes bottom coating (S210), middle coating (S220), and top coating (S230), as illustrated in FIGS. 1 and 2. Further, the surface-treating (S100) includes degreasing a material (S110) and shot blasting (S120) as illustrated in FIG. 3, and the top coating (S230) includes mixing TPU/DMF (S231), penetrating the TPU/DMF (S232), removing DMF (S233), and bonding BP/TPU (S234) as illustrated in FIG. 8.

First, in the multilayer coating method for preventing erosion due to cavitation according to the present invention, in the surface-treating (S100), shot blasting or shot peening which enhances fatigue strength while curing the surface of the material 100 is performing by generating compressive residual stress on the surface of the material by spraying hard particles so as to form a minute unevenness 110 on the surface of the material 100 as illustrated in FIGS. 1 to 4.

In more detail, the surface-treating (S100) includes the degreasing of the material (S110) in which caustic soda and a degreasing agent are degreased on the surface of the material 100 at 50° C. for 5 minutes, and the shot blasting (S120) in which, shot blasting or shot peening is performed for 8 seconds on the degreased surface of the material 100. The decreasing of the material (S110) is to remove oils before performing the surface-treating on the surface of the material 100. The surface treatment needs to be performed after various kinds of oils such as mineral or vegetable oils are bonded onto the surface of the material 100 to be fully removed. In the degreasing of the material (S110), largely, there are solvent degreasing and emulsion degreasing, and an emulsifier or dirt which remains after being cleaned with warm water may be removed after the degreasing is finished. The shot blasting or the shot peening in the shot blasting (S120) is a kind of surface-curing method of removing a scale, molding sand, or the like by spraying shots (round metal, glass, ceramic particles, and the like) to the material 100 at air pressure or centrifugal force (approximately 2,000 rpm), generating residual compressive stress on the surface of the material 100, and curing the surface by process curing. As a result, the fatigue strength is increased on the surface of the material 100 and the minute unevenness 110 due to plastic deformation is formed on the surface of the material 100 by hitting the shots.

A test is performed for comparing a change in surface modification of the material 100 with the surface-treated specimen in the related art through the aforementioned surface-treating (S100). Through the test, first, how much the erosion due to the cavitation is prevented by improving the strength of the material itself and second, a degree of the adhesion to the primer layer 200 during bottom coating to be described below will be cheeked.

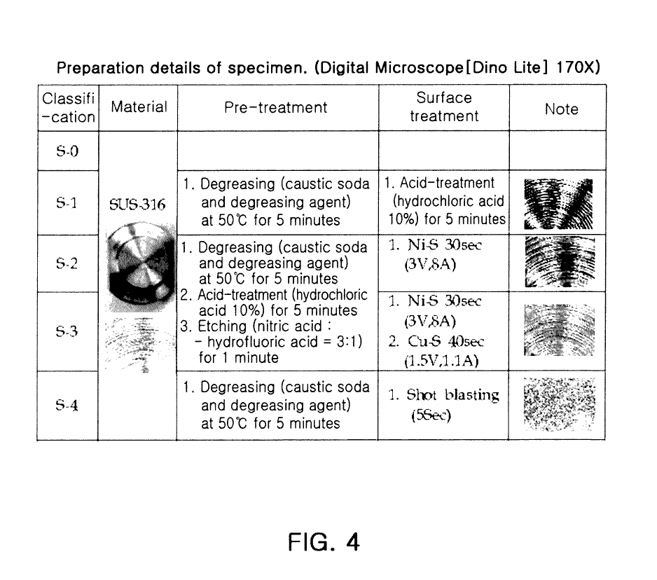

First, a sonicator generates a rated output of 20 kHz through an electronic circuit by inputting power of 220 V and 60 Hz to supply the power to various devices such as a vibrator. The ultrasonicator includes a controller, an automatic stop timer, an amplifier, a vibrator, a horn, and the like. The vibrator serves to convert electric energy to vibration energy by receiving energy from a generator to transfer the converted vibration energy to the amplifier. For a modification effect assay of the surface of the material 100, as illustrated in FIG. 4, each specimen is prepared and the assay is performed as follows. That is, the assay method includes 1) preparing the specimen—measuring roughness and a fine shape laser, 2) operating the specimen, 3) measuring the roughness and photographing the fine shape laser after operating the specimen, 4) bottom-coating the specimen, 5) testing acceleration of cavitation of the specimen, and 6) measuring and analyzing an erosion amount of the specimen.

A material, of the basic specimen is S-0 of SUS-316. Herein, with respect to a specimen S-1 acid-treated after decreasing,, a specimen S-2 platted with Ni by etching after degreasing and acid-treating, and a specimen S-3 platted with Ni and Cu by etching after degreasing and acid-treating, and a specimen S-4 shot blasted after degreasing according to the surface-treating (S100) of the present invention; the operating of each specimen is performed. After bottom-coating each specimen on the primer layer 200, the cavitation acceleration test is performed.

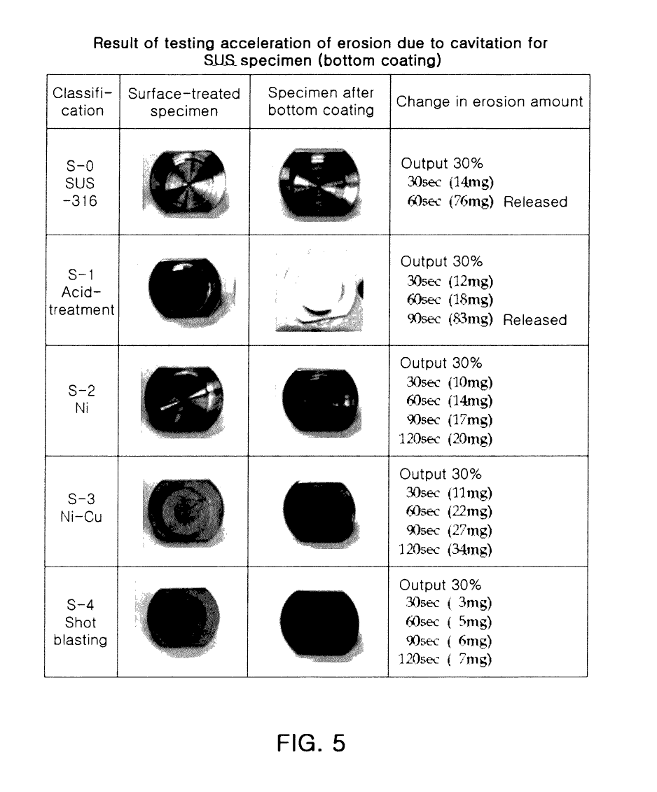

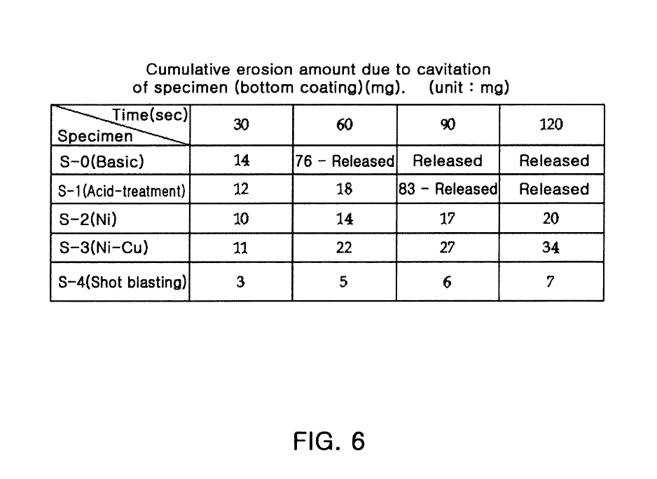

As a result, the result of measuring and analyzing the erosion amount of each specimen is illustrated in FIGS. 5 and 6. Of course, the specimen S-0 is released after 60 seconds and the specimen S-1 is released after 90 seconds. In the related art, the specimen S-2 platted with Ni and the specimen S-3 platted with Ni—Cu are not released even after 120 seconds, but the erosion amounts are 20 mg and 34 mg after 120 seconds, respectively. However, it can be seen that the specimen S-4 through the surface-treating (S100) according to the present invention is eroded by 1 mg from 3 mg per 30 sec from 30 seconds to 120 seconds to have the erosion amount of 7 mg, finally, as illustrated in FIGS. 5 and 6. That is, the surface of the material 100 which is subjected to the surface-treating (S100) according to the present invention is surface-treated by shot peening or shot blasting to improve adhesion to the primer layer 200 in the bottom-coating (S210) through the minute unevenness 110 even while ensuring wear resistance and high stiffness of the material 100 itself.

For the multilayer-coating (S200), bottom, intermediate, and top coatings on the material 100 which is surface-treated are sequentially performed as illustrated in FIGS. 1 and 2. In detail, the multilayer-coating (S200) includes bottom-coating (S210) of forming the primer layer 200 by using an organic primer, middle-coating (S220) of forming the TPU layer 300 by using thermoplastic polyurethane (TPU), and top-coating (S230) of forming and bonding the BP/TPU complex layer 400 by penetrating a TPU solution to a prepared carbon nanotube (CNT) film.

The bottom-coating (S210) as a process of forming the primer layer 200 uses an organic primer such as polyethylene (PE) or polypropylene (PP). The organic primer has no foam on the film during curing, excellent curability and heat resistance, no error on the appearance of the film even though being immersed in alkali water, high retention of a physical property, and high adhesion with the material 100 to be used as an adhesive and forms the primer layer 200 as illustrated in FIG. 2.

The middle-coating (S220) is a process of forming the TPU layer 300 by using the TPU solution. The TPU is generally prepared by reacting 1) hydroxyl-terminated polyether or hydroxyl-terminated polyester, 2) a chain extender, and 3) an isocyanate compound. The TPU includes various types of compounds for the three reactants, and is a segmented polymer having polyol forming soft segments and isocyanate forming hard segments.

According to the chemical features, the TPU has excellent flexibility and elasticity and good chemical resistance, dimensional stability, heat resistance, oxidation resistance, and creep resistance. Particularly, the TPU has high adhesion to be used as an adhesive, and as illustrated in FIG. 2, the TPU layer 300 is coated on the primer layer 200 to be firmly bonded to each other. As described above, it is possible to increase adhesion between the primer layer 200 which is bottom-coated through the middle-coating (S220) of forming the TPU layer 300 by using the TPU and the BP/TPU complex layer 400 in the top-coating (S230) to be described below and distribute impact applied to the BP/TPU complex layer 400 by absorbing the impact due to the cavitation through high flexibility and elasticity.

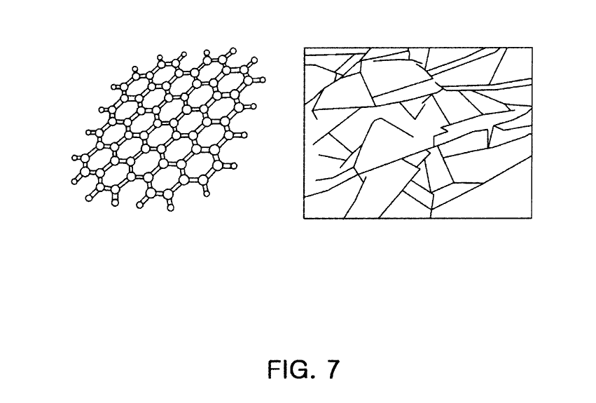

In the top-coating (S230), as illustrated in FIG. 7, the BP/TPU complex layer 400 is formed and bonded by penetrating the TPU solution to the prepared CNT film. The CNT is formed with only carbon atoms having a diameter of several to several tens of nanometers, as a tube type structure in which the inside of a hexagonal honeycomb in which one carbon atom is bonded with other three carbon atoms is empty as illustrated in a left side of FIG. 7. The CNT has excellent thermal conductivity like diamond, much excellent electric conductivity as compared with copper, and excellent strength which is 100 times better than steel having the same thickness. Particularly, carbon fiber is broken even by 1% deformation, while the CNT is deformed at 15% to be bearable.

However, the aforementioned CNT is ideal as a filter material, but is agglomerated between molecules due to van der walls force and thus, is not used as a filler material as it is. Up to now, various methods of dispersion have been developed and the most widely used method is treatment with strong acid such as sulfuric acid and nitric acid. As the treated result, structural damages of the CNT occur, and simultaneously, the CNT is cut during treatment, and thus, an aspect ratio is changed. Further, as an addition concentration of the CNT is increased, the viscosity of the mixed solution is increased, and thus, it is more difficult for the CNT to be dispersed. In the present invention to solve the problem, the BP/TPU complex layer 400 is formed by penetrating the TPU solution to the CNT film generated after generating the CNT film.

To this end, the CNT film is prepared as a film with a thickness of about 20 μm by centrifuging the mixed solution in a centrifugal of 4,000 rpm for 30 minutes after dispersing CNT with purity of 95% or more, an appropriate amount of surfactant (for example, Triton X-100), and distilled water for 20 minutes by using a ultrasonicator and passing a floating part in which the CNT is largely agglomerated in the centrifuged mixed solution through a membrane filter having a hole size of 0.22 μm. The prepared CNT film is illustrated in a right side of FIG. 7. As described above, after the CNT film is prepared, as illustrated in FIG. 8, in the top-coating (S230), particularly, mixing the TPU/DMF (S231), penetrating the TPU/DMF (S232), removing the DMF (S233), and bonding the BP/TPU (S234) are performed. The particular processes of the top-coating (S230) are to enhance penetration of the TPU because the CNT film as a porous film may not penetrate the TPU solution as it is due to low wettability.

In the TPU/DMF-mixing (S231), the TPU/DMF mixed solution is formed by mixing the TPU solution with dimethylformamide (DMF) of 0.01 wt %. The DMF is a representative polar organic solvent as one of formic acid amide and industrially prepared by reacting with carbon under pressure by adding a sodium methylate catalyst to dimethyl amine generated by reaction of methanol and ammonia. The DMF is used as a solvent of a polar compound in organic synthesis and used as a solvent of polyacryl nitrile In the polymer. The DMF is mixed with the TPU solution to be penetrated to the CNT film.

In the TPU/DMF-penetrating (S232), the TPU/DMF mixed solution is penetrated to the CNT film in a vacuum state. The reason why the TPU/DMF mixed solution is penetrated to the CNT film in a vacuum state is that penetration efficiency is increased by penetrating the TPU/DMF mixed solution in the vacuum state in which air is removed in each pore of the CNT film because it is difficult to penetrate the TPU/DMF mixed solution due to low wettability of the CNT film.

In the DMF-removing process (S233), the DMF is removed by drying the CNT film penetrated with the TPU/DMF mixed solution for 24 hours at 60° C. in a vacuum state to form the BP/TPU complex layer 400. The CNT film is called a CNT film or a buckypaper, and written as BP as the abbreviation of the buckypaper in this meaning and the buckypaper penetrated with the TPU is called as the BP/TPU complex layer 400.

In the BP/TPU --bonding process (S234), the BP/TPU complex layer 400 with the removed DMF is bonded with the intermediate-coated TPU layer 300, In this case, the intermediate-coated TPU layer 300 and the BP/TPU complex layer 400 are firmly bonded with each other by the TPU which is the same material, and erosion due to the cavitation may be largely reduced while maintaining high toughness due to the CNT film of the top-coated BP/TPU complex layer 400.

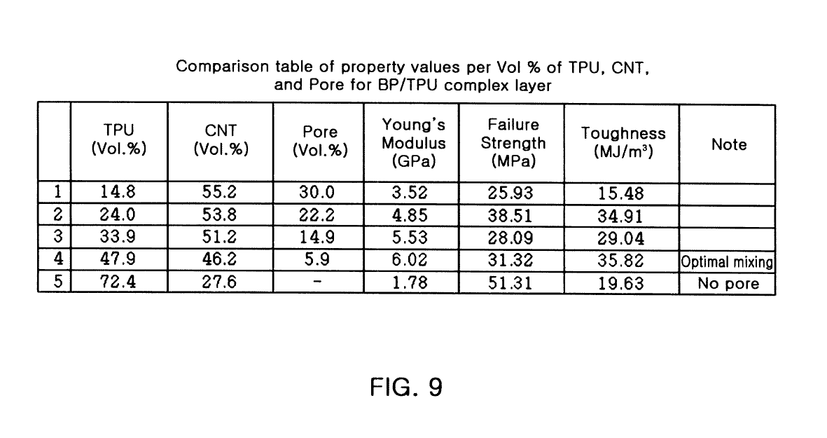

In the BP/TPU complex layer 400, a property value varies according to the penetration amount and porosity of the TPU to the CUT of the CNT film (BP) as illustrated in FIG. 9. Accordingly, Young's modulus, fracture strength, and toughness need to be found through an optimal mixed ratio. That is, when the penetration amount of the TPU to the CNT of the CNT film (BP) is 47.9 Vol % and in this case, the porosity is 5.9 Vol %, the BP/TPU complex layer 400 has maximum Young's modulus and toughness values as an optimal mixed ratio. However, the fracture .strength Is increased as the porosity is decreased, but it can be seen that when the Young's modulus value and. the toughness value are large or smaller based on the optimal, mixed ratio, the fracture strength is rapidly decreased.

Accordingly, when the residual porosity is 5.5 to 6.5 Vol % of the CUT film (BP) and the content of the TPU is 45 to 50 Vol %, the BP/TPU complex layer 400 has relatively high fracture strength while having maximum Young's modulus and toughness. Furthermore, when the residual, porosity is 5.9 Vol % of the CNT film (BP) and the content of the TPU is 47.9 Vol %, the content of the CNT is 46.2 Vol %, and thus, the BP/TPU complex layer 400 has the optimal mixed ratio. In this case, the Young's modulus is 6.02 GPa, the fracture strength is 31.32 MPa; and the roughness is 35.42 MJ/m³.

As described above, in the multilayer coating method for preventing erosion due to the cavitation according to the present invention, first, it is possible to improve adhesion to the primer layer 200 in the bottom-coating (S210) through the minute unevenness 110 even while ensuring wear resistance and high stiffness of the material 100 itself by surf ace-treating the material 100 by shot peening or shot blasting.

Second, it is possible to increase adhesion between the primer layer 200 which is bottom-coated through the middle-coating (S220) of forming the TPU layer 300 by using the TPU and the BP/TPU complex layer 400 in the top-coating (S230) and distribute impact applied to the BP/TPU complex layer 400 by absorbing the impact due to the cavitation through high flexibility and elasticity.

Third, it is possible to greatly reduce erosion due to the cavitation while the TPU layer 300 and the BP/TPU complex layer 400 which are intermediate-coated through the top coating (S230) in which the BP/TPU complex layer 400 is formed and bonded by penetrating a thermoplastic polyurethane solution to the CNT film are strongly bonded with each other by the TPU which is the same material and high toughness is maintained by the CNT film, of the top-coated BP/TPU complex layer 400.

Particularly, it is possible to provide a characteristic penetration method of thermoplastic polyurethane to the CNT film formed together with the specific forming method of the CNT film during top coating and ensure wear resistance and high stiffness which are enhanced as compared with the related art by ensuring an optimal penetration amount.

It should not be analyzed that the exemplary embodiments of the present invention, which are described above and illustrated in the drawings limit the technical spirit of the present invention. The scope of the present invention is limited by only matters described in the appended claims and various modifications and changes of the technical spirit of the present invention can be made by those skilled in the art. Accordingly, the

modifications and changes will be included in the protection scope of the present invention if the modifications and changes are apparent to those skilled in the art.

What is claimed is:

1. A multilayer coating method for preventing erosion due to cavitation, the method comprising:
surface-treating for performing shot blasting or shot peening for curing the surface of a material and increasing a fatigue strength by injecting hard particles and generating residual compressive stress on the surface of the material so that minute unevenness is formed on the surface of the material; and
multilayer coating for sequentially performing bottom, middle and top coating with respect to the material In which surface treatment is completed,
wherein the multilayer coating includes
bottom coating for forming a primer layer by using an organic primer,
middle coating for forming a TPU layer by using thermoplastic polyurethane (TPU), and
top coating for forming and bonding a BP/TPU complex layer by penetrating a thermoplastic polyurethane solution into a previously prepared carbon nanotube (CNT) film.

2. The multilayer coating method of claim 1, wherein; the surface-treating includes
material degreasing for degreasing caustic soda and a degreasing agent on the surface of the material at 50° C. for 5 minutes, and
shot blasting for performing shot blasting or shot peening on the surface of the degreased material for 5 seconds.

3. The multilayer coating method of claim 1, wherein the CNT film is prepared to have a film having a thickness of approximately 20 μm by distributing and processing the carbon nanotube having purity of 95% or higher, a an appropriate amount of surfactant, and distilled water by using an ultrasonicator for 20 minutes, centrifuging a mixed solution in a centrifugal of 4,000 rpm for 30 minutes and taking a floating part where the carbon nanotube is largely agglomerated in. the centrifuged mixed solution, and passing the floating part through a membrane filter having a hole size of 0.22 μm.

4. The multilayer coating method of claim 1, wherein the top coating includes
TPU/DMF mixing for forming a TPU/DMF mixed solution by mixing the TPU solution and dimethyl formamide (DMF) of 0.01 wt %,
TPU/DMF penetrating for penetrating the TPU/DMF mixed solution into the CNT film in a vacuum state,
DMF removing for forming the BP/TPU complex layer by drying the CUT flits into which the TPU/DMF mixed solution is penetrated in the vacuum state of 60° C. for 24 hours to remove the dimethyl formamide, and
BP/TPU bonding for bonding the BP/TPU complex layer from which the DMF is removed onto the TPU layer which is middle-coated.

5. The multilayer coating method of claim 4, wherein in the BP/TPU complex layer, the residual porosity of the CNT film is 5.5 to 6.5 Vol %.

6. The multilayer coating method of claim 5, wherein in the BP/TPU .complex layer, the content of the thermoplastic polyurethane is 45 to 50 Vol %.

7. The multilayer coating method of claim 6, wherein in the BP/TPU complex layer, the residual porosity of the CNT film is 5.9 Vol % and the content of the thermoplastic polyurethane is 47.9 Vol %.
